(19) United States
(12) Patent Application Publication
(10) Pub. No.: US 2007/0192154 A1
(43) Pub. Date: Aug. 16, 2007

(54) Managing Service Requirements for Airports

(75) Inventors: Amit Chakraborty, East Windsor, NJ (US); Saikat Mukherjee, North Brunswick, NJ (US); Paul Camuti, Belle Mead, NJ (US); Ramesh Viswanathan, Kendall Park, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/668,113

(22) Filed: Jan. 29, 2007

Related U.S. Application Data
(60) Provisional application No. 60/772,045, filed on Feb. 10, 2006.

(51) Int. Cl. G05B 19/418

(52) U.S. Cl. 705/8; 702/184

(57) ABSTRACT

Disclosed is a method for the creation of maintenance plans. The maintenance plans are created by determining the service requirements for equipment, and normalizing the service requirements. These service requests are formalized in the language of XML Schema and semantic heterogeneity between different plans resolved with the use of ontologies. The matched service requests are combined to form the global service plan. Finally, resources may then be allocated to execute the created maintenance plans and appropriate maintenance schedules are identified based in the created maintenance plans.

This application claims the benefit of U.S. Provisional Application No. 60/772,045 filed Feb. 10, 2006, which is incorporated herein by reference.

### BACKGROUND OF THE INVENTION

The present invention relates generally to the management of service requirements, and more particularly to the management of service requirements and the formation of maintenance plans for equipment in an airport environment. The invention is responsive to significant challenges that are currently faced in the management of service requirements, especially those at airports. Some of these challenges are discussed in what follows.

Maintaining complex equipment properly within an airport is a difficult task, yet is key for the smooth flow of traffic through the airport and the overall security of the airport. One of the major sources of complications is related to the enormous variety of equipment used within an airport environment. From passenger check-in to when passengers leave the airport, different tasks within the airport use different equipment from many different manufacturers each of which may have different maintenance requirements.

Servicing such a complex infrastructure is not simple. This is because of the large diversity in the nature of the equipment both in terms of functionality as well as their source. This inherent complexity is further exacerbated by the lack of a standard procedure for collecting information regarding the status of the equipment. Additionally, every equipment manufacturer has their own set of rules and guidelines that determine the maintenance requirements for a given status of the equipment. The problem is compounded by the frequent use of different descriptions for the same service procedure or part. Finally, for purposes of efficient resource utilization, it is necessary to create a global service plan based on the service requirements of individual equipment. Such a global service plan would lead to a cost-effective servicing protocol in a complex environment such as an airport.

Therefore, there is a need for a comprehensive strategy for the management of equipment service requirements and the formation of maintenance plans for equipment that takes into account the above issues.

### BRIEF SUMMARY OF THE INVENTION

The present invention is a method for the creation of maintenance plans. In the inventive method, the maintenance plans are created by determining the service requirements for equipment, and normalizing the service requirements. Finally, resources may then be allocated to execute the created maintenance plans and appropriate maintenance schedules may be identified based in the created maintenance plans.

In specific embodiments, the service requirements may be standardized; determined from equipment state data and/or maintenance schedules; and normalized using input from a maintenance knowledgebase and/or a service schema.

In other specific embodiments, the maintenance plans cover different types of equipment from different manufacturers and may have normalized activity references and/or normalized resource references.

These and other advantages of the invention will be apparent to those of ordinary skill in the art by reference to the following detailed description and the accompanying drawings.

### BRIEF DESCRIPTION OF THE DRAWINGS

FIG. 1 is a schematic representation of the architecture of one embodiment of the invention;

FIG. 2 is a flowchart of the steps of one embodiment of the invention; and

FIG. 3 is a schematic representation of a high level block diagram of a computer capable of implementing the present invention.

### DETAILED DESCRIPTION

Because there are many different types of equipment used in any complex environment, such as within an airport environment, there are many different rules and guidelines that determine the maintenance requirements for the many different types of equipment. These different maintenance requirements may use different descriptions for the same service procedure or part. Therefore, in one aspect, the Applicants' invention analyzes the different maintenance requirements for the different types of equipment and creates standardized service requirements for the equipment. It then creates a maintenance plan for the equipment using the standardized service requirements. The following is an exemplary embodiment of the invention.

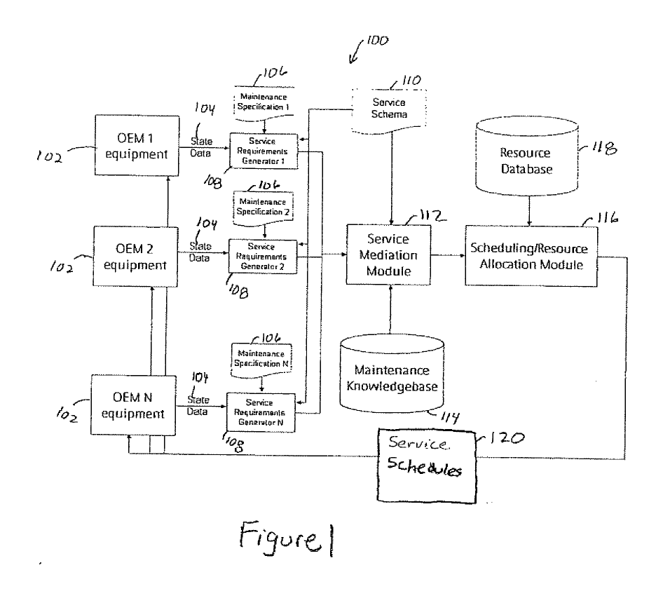

An exemplary maintenance scenario is modeled as a closed loop system 100 as shown in FIG. 1. The overall system for a single airport consists of N different pieces of equipment 102, each from a different manufacturer. However, this does not preclude multiple pieces of equipment coming from the same manufacturer.

All of the state data 104 that comes out of each system consists of two parts: one part is standardized data that describes the status of the different units and the other part is unique to the different manufacturers. The standardized data determines maintenance sojourns and can also be used for monitoring.

The equipment 102, based on their function, age, and operating condition are in different states of operation. State data 104, regarding the different states of operation, is collected and may reflect, for example, usage time since the last maintenance and other diagnostic information.

Every manufacturer has their own maintenance specifications 106 which need to be taken into consideration along with the state data 104 to determine the service/maintenance needs.

The maintenance specification 106 is combined with the operating information to create the service requirements. This is similar to answering a set of diagnostic questions and completing a form that can morph itself to different documents based on the information entered. For instance, based on the operating state data 104, the maintenance specifications 106 might require a sub-unit to be replaced or overhauled, which can trigger a request for certain parts and personnel with a pre-specified skill-set.

The service schema 110 is a standardized way of describing all requirements for a service/maintenance job. Each Service Requirements Generator module 108 generates a service requirement for the corresponding equipment 102 taking into consideration the state of the equipment 102 and the Original Equipment Manufacturer's (OEM's) maintenance specification 106. This is expressed in terms of the service schema 110.

The Service Mediator module 112 is responsible for taking into consideration all of the service requirements from the different units and integrating them into a standardized set of maintenance requirements. In addition to the requirements from the individual machines, it also takes as input the standardized service schema and information from a maintenance knowledgebase 114. It is possible that the same part could be necessary for several pieces of equipment 102, but each manufacturer uses their own part number and code to describe them. The same could be true for tools and experts needed to execute the maintenance job. It is the job of the Service Mediator module 112 to integrate these requirements and normalize or standardize the information wherever necessary. In this application, the terms normalize and standardize are used interchangeably to have the same definition. The maintenance knowledgebase 114 stores domain information that helps in semantic reconciliation.

Finally, the scheduling/resource allocation module 116 takes as input the integrated service requirements and the available resources from the resource database 118. Then, the scheduling/resource allocation module 116 uses a resource constrained optimization technique to come up with a set of maintenance plans and service schedules 120 for the different equipment 102.

Some of the individual aspects will now be described in detail. Before servicing equipment belonging to a diverse set of OEMs in a complex environment such as an airport, a global service requirement description must be created from the individual descriptions provided by each OEM. The service schema 110 is used for describing the service information because of the diversity of OEMs. The service schema 110 is used in the specification of service requirements of each OEM. The resolution of discrepancies between the service requirements and the creation of the final global service requirement are performed within the Service Mediation module 112.

The Service Schema 110 is represented using the syntax of XML Schema. XML Schema is a W3C standard for defining structured content using components to constrain the meaning and usage of constituent parts of a XML document: the data types, elements and their content, attributes and their values. The modeling power of XML Schema, with its ability to define complex data types as well as specify constraints, provides sufficient expressiveness to represent service descriptions. The syntax of regular expressions is used to succinctly express the Service Description Language in terms of XML Schema elements.

In the following “*” denotes the occurrence of zero or multiple times of the corresponding element, “+” denotes the occurrence of at least once of the corresponding element, while “|” and “,” represent disjunction and conjunction respectively. Note that the use of XML Schema permits integer, double, and date elements apart from strings as primitive data types. Attributes of a schema element are represented as the predicate attributeList and attribute values are restricted to be Boolean (i.e. true and false only).
Service=(Activity+, PrecedenceConstraint*, DurationConstraint*)
Activity=(Name, Cost, SubActivities, ReqdResources)
attributeList(Activity)=(is Interruptible)
SubActivities=Activity*
ReqdResources=Resources*
Resource=(Name, Cost)
attributeList(Resource)=(isRenewable)
PrecedenceConstraint=(ActivityBefore, ActivityAfter)
ActivityBefore=(Activity|ActivityBefore+)|Activity
ActivityAfter−(Activity|ActivityBefore+)|Activity
DurationConstraint=(Resource|Activity, Duration)
Duration=(Starttime, Endtime)
StateData=Attribute*
Attribute=(Name, Value+|ValueRange)
ValueRange=(Value, Value)
attributeList(Attribute)=(isOEMSpecific)
MaintenanceOEM=MaintenanceRuleOEM*
MaintenanceRuleOEM=(Guards+, Service+)
Guards=(Guard|Guards+)|Guard
Guard=(Attribute, Constraint, Value)
Constraint=(equals|lessThan|greaterThan)
Name=string
Cost=double
Starttime=date
Endtime=date
Value=string|double|integer|date

The schema element Service represents a single servicing request and consists of a set of activities, precedence and duration constraints. Each activity represents a servicing task. An activity is modeled as a set of a (string) name, a (double) cost, a set of subactivities, and a set of resources required for its functioning. Note that the sets of subactivities and required resources could be empty signifying situations, respectively, when an activity does not spawn dependent subactivities and does not consume any resources for its execution. A resource is modeled as a name and an associated (double) cost.

The cost of a resource quantifies the expense involved in using it for servicing activities. Constraints impose conditions on the use and behavior of activities and resources. The Service Schema 110 is restricted to temporal constraints on activities and resources since most constraints in a service environment can be represented using them. Precedence constraints act only on activities and specify a disjunctive set of activities which needs to be performed before another disjunctive activity set. Duration constraints can be defined both on activities as well as resources and specify a time interval, between start and end times, when the activity has to be performed or the resource has to be consumed.

The Service Schema 110 is used to structure the definition of service information within the overall framework of the process. Therefore, the schema acts on the service requirement generator 108 as well as the service mediator module 112.

The Service Requirement Generator 108 publishes the service descriptions of the corresponding OEM in terms of the Service Schema 110. The inputs to this module are State Data 104 and Maintenance Specification 106. State Data 104 describes the current state of the equipment 102 and is modeled as a set of attribute-value pairs.

An attribute is represented by the schema element Attribute and consists of a string Name and either a single Value, an enumeration of Values, or a range between a start and an end Values. A Value can be either string, double, integer, or date. The schema attribute isOEMSpecific indicates whether the corresponding Attribute is generic (false) or is particular to the OEM (true).

Maintenance Specification 106 is OEM specific information detailing the service requirements of a piece of equipment 102 given its state. It is modeled as a set of servicing rules (schema element MaintenanceRuleOEM). A rule is activated if the set of preconditions (schema element Guards) is true and results in the set of service requirements (schema element Service). Each precondition (Guard) is modeled as a constraint (Constraint) between an attribute (Attribute) and its value (Value). Constraints can be either equal to, less than, or greater than and hold true when the current value of the attribute is either equal to, less than, or greater than the value specified in Value. Note that the use of disjunction in the definition of Guards allows specifying service rules with a combination of disjunction and conjunction of constraints on attribute values.

The output from each Service Requirement Generator 108 is a set of servicing requirements based on the current state of the equipment 102. These service requests from the different OEMs are gathered and sent as input to the Service Mediator module 112.

The Service Requirements Generator 108 sends the service requirement description in vocabulary terms corresponding to its OEM. Since individual OEMs conform to their own vocabularies, this results in semantic heterogeneity between the service requirement descriptions of the different OEMs. Thus, in order to create the global requirement description, the Service Mediation module 112 must resolve this heterogeneity.

The semantic heterogeneity is resolved by the use of an ontology. An ontology is a formalized, machine understandable description of the semantics of a domain. The domain of interest is OEM servicing in airports and the semantic heterogeneity is between the names of activities and resources being referred to in different OEM-specific service requirements.

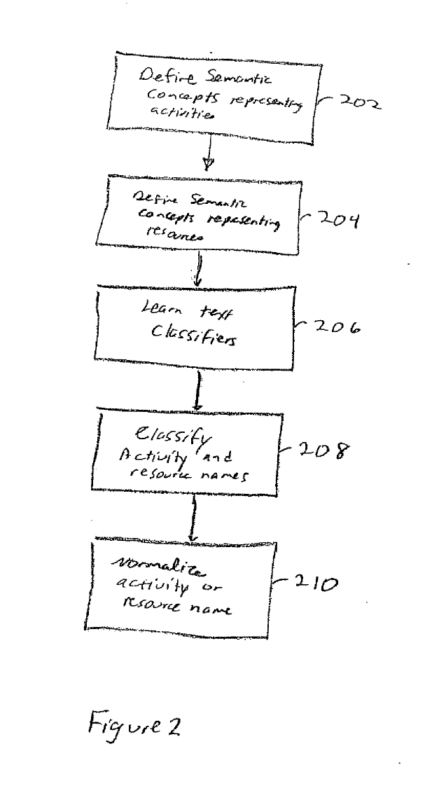

Therefore, as shown in FIG. 2, the Service Mediation module 112 performs the following steps. In step 202, a set of semantic concepts representing activities or tasks in airport servicing is defined. In step 204, a set of semantic concepts representing resources in airport servicing is defined. In step 206, text classifiers for each of the defined concepts are learned. The text classifiers will be trained from text descriptions of concept instances from different OEMs. In step 208, text descriptions of the activity and resource names from individual OEMs will be used to classify them to the appropriate semantic concept. In step 210 the names of the semantic concepts will be normalized and used as the normalized activity or resource name.

The final output from Service Mediation module 112 will be a set of service requests with normalized activity and resource references. These service requests, corresponding to different OEMs, are sent to the Scheduling/Resource Allocation module 116 for creating a global service plan satisfying as many constraints as possible.

The Scheduling/Resource Allocation module 116 is responsible for receiving the maintenance and service requirements that are output by the Service Mediation module 112 and converting them into feasible plans that are cost-effective. The Scheduling/Resource Allocation module 116 receives as input a set of requirements and then sends out a set of plans for the different pieces of equipment 102. Also, the plans have different profiles based on how complex the systems are and what maintenance requirements they have.

There are several resources that must be considered, both renewable and non-renewable, that are necessary, to execute a plan. Planning and scheduling is a constrained resource optimization problem, and in this case it assumes an added dimension due to the fact that the plans for the different equipment or machines under contract are from different OEMs. Since the goal is to come up with maintenance plans that are cost-effective, the first step in the process is to understand the costs and constraints that pertain to the resources.

One resource, parts, must be acquired, so there is no scope of further optimization in terms of the actual parts. However, a good planning system will be able to predict the parts requirement before they are needed, so that they can be acquired before they are actually required.

Another resource is personnel. Most maintenance organizations have on their staff, a set of experts and the goal is to use their time effectively across the different plans. Resource leveling must also be considered. Resource leveling means that any organization would like to avoid cycles when a certain set of resources, in this case, the expert's time, would be needed at a level higher than what is available and at others the same resources could be idle. These resources are considered renewable. The same idea holds true for the case of tools and equipment, since they also need to be ‘resource-leveled’ so that one doesn't have to either rent/buy additional items or idle them at other times.

Given the above, the whole problem can be formulated, as an example, as a large project with the following:
Consider a project set J with J tasks {1, . . . ,J}
Add dummy start and end tasks 0 and J+1
Each task has a duration pⱼ. p₀=p_{J+1}=0
A task starts a Sⱼ. S₀=0, S_{J+1}=project duration
Project has temporal constraints. Two tasks i, j: Sⱼ=Sᵢ+dᵢⱼ. dᵢⱼ may have both lower and upper bounds.
Ex: Task 5 cannot be started before task 3 is finished→S₅≧S₃+p₃, equivalently, d₃₅≧p₃
Temporal relations can be represented by a network N⁺=(V,E): node j⇄task j, arc o̅ᵢⱼ⇄temporal constraints dᵢⱼ≧ o̅ᵢⱼ
If the project has a due date d, then S_{J+1}≦S₀+d→d_{J+1}, 0≧−d
The project has a resource set K with K resources {0, . . . ,K−1}
Each renewable resource has a constant limit Rₖ
If resource availability varies over time, we can convert them to fixed ones by introducing some schedule-fixed dummy tasks
Each task j consumes rⱼₖ units of resource k during its execution
If a task requires variable amount of resources over time, we can divide it into subtasks and impose extra temporal constraints to bind them
R₀ₖ=r_{J+1},k=0, for all resource k
Time can be either continuous or discrete (e.g., hour or day)
Time windows are important in project scheduling: ESⱼ, LSᵢ, pⱼ are earliest start, latest start and duration for task i
While pⱼ is given in planning, ESⱼ, LSⱼ can be obtained by running all-pair longest path algorithm on N+

The above can be formulated as an integer programming formulation as:

$$min {\sum }_{keK} {c}_{k} {max}_{t} {\sum }_{j - 1}^{J} {r}_{jk} {\sum }_{b - t - {p}_{j} + 1}^{t} {x}_{jb} ( resource usage level )$$

$$s . t . {\sum }_{t - ES}^{{LS}_{j}} {x}_{jt} = 1 , {∀}_{j} ∈ V \backslash \{ 0 \} , {x}_{00} = 1$$

$${\sum }_{t - {ES}_{j}}^{{LS}_{j}} t \cdot {x}_{jt} \geq {\sum }_{t - {ES}_{i}}^{{LS}_{i}} t \cdot {x}_{it} + {S}_{u} , {∀}_{ij} , j ∈ V$$

$${\sum }_{j - 1}^{J} {Y}_{jk} {\sum }_{b - t - {p}_{j} + 1}^{t} {x}_{jb} \leq {R}_{k} , ∀ k ∈ K , t ∈ \{ 0 , … , d - 1 \}$$

$${x}_{jt} = \{ 0 , 1 \} , {∀}_{j} ∈ V \backslash \{ 0 \} , t ∈ \{ {ES}_{j} … {LS}_{j} \}$$

Where cₖ is the cost of the total resource consumed of type k, and xⱼ=1 iff task j starts at time t or 0 otherwise. Task start times are determined by solution x:

$${s}_{j} = {\sum }_{t - 0}^{d - 1} {tx}_{jt}$$

for all tasks j.
The above can be solved using a branch and bound algorithm, the pseudo-code for which is given below:

1. Load input

2. Preprocessing
cut the search space
generate a starting branch b (each branch is uniquely represented by a partial solution)
Set current upper bound UB as the upper bound of b
Set branch set B={b}

3. While the search space S is NOT empty
Remove a b from B; do scatter search in S starting from each b in B if the hard lower bound HLB of b is LOWER than the current UB; add the newly found branches to B
Reduce UB if a feasible partial solution with lower UB is found
Cut the space that has been searched from S
Order the branches in B in the increasing order of their easy lower bounds ELB's

The output of the Scheduling/Resource Allocation module 116 is a plan along with a schedule. However, in reality, this consists of multiple plans since it is a plan for the integrated requirements that serve all the pieces of equipment 102.

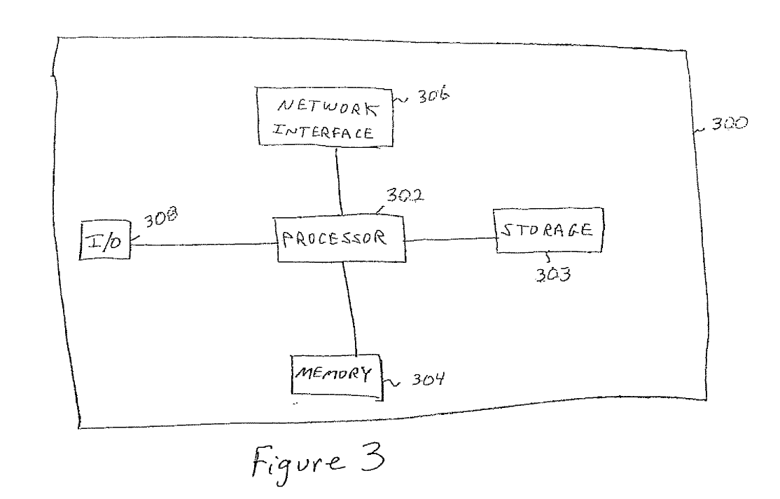

The method according to the present invention can be implemented as a computer program executed by a computer. For example, the method may be implemented on a computer using well known computer processors, memory units, storage devices, computer software, and other components. A high level block diagram of such a computer is illustrated in FIG. 3. Computer 300 contains a processor 302 which controls the overall operation of the computer 300 by executing computer program instructions, which define such operation.

The computer program instructions may be stored in a storage device 303 (e.g., magnetic disk) and loaded into memory 304 when execution of the computer program instructions are desired. Thus, the method and system can be defined by the computer program instructions stored in the memory 304 and/or storage 303 and the method will be controlled by the processor 302 executing the computer program instructions. The computer 300 also includes one or more network interfaces 306 for communicating with other devices via a network. The computer 300 also includes input/output 308 which represents devices which allow for user interaction with the computer 308 (e.g., display, keyboard, mouse, speakers, buttons, etc.). One skilled in the art will recognize that an implementation of an actual computer will contain other components as well, and that FIG. 3 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method of creating maintenance plans for a plurality of equipment comprising:
analyzing service requirements of at least two pieces of equipment to standardize service requirements, at least one of said pieces of equipment having non-standard service requirements;
creating standardized service requirements for the at least one piece of equipment having non-standard service requirements; and
creating a maintenance plan using the standardized service requirements.

2. The method of claim 1 further comprising allocating resources to the maintenance plan.

3. The method of claim 2 further comprising determining maintenance schedules from the maintenance plan.

4. The method of claim 1 wherein creating standardized service requirements comprises resolving semantic heterogeneity between names of activities in the service requirements through the use of ontological domain knowledge.

5. The method of claim 1 wherein the service requirements are determined from equipment state data.

6. The method of claim 1 wherein the service requirements are determined from maintenance schedules.

7. The method of claim 1 wherein the service requirements are standardized using data from a maintenance knowledgebase.

8. The method of claim 1 wherein the service requirements are standardized using input from a service schema.

9. The method of claim 8 wherein the service schema is an XML schema.

10. The method of claim 8 wherein an instance of the service schema represents a single servicing request and includes activities, precedence and duration constraints.

11. The method of claim 10 further comprising the step of modeling the precedence constraints as a temporal ordering among activities and modeling duration constraints with specific start and end times between which the activities must be performed.

12. The method of claim 1 wherein the maintenance plans bring together service requests for different types of equipment from different manufacturers.

13. The method of claim 12 further comprising the step of modeling the service requests as a collection of rules where each rule has certain conditions which when satisfied trigger associated service requests.

14. The method of claim 1 wherein the maintenance plans are for equipment from different manufacturers.

15. The method of claim 1 wherein the service requirements have standardized activity references.

16. The method of claim 1 wherein the service requirements have standardized resource references.

17. The method of claim 1 wherein the service requirements are modeled as activities which consume resources.

18. The method of claim 17 wherein the activities in the servicing request include an associated name, cost, required resources, and are hierarchically decomposed into subactivities.

19. The method of claim 17 further comprising the step of modeling the resources with a name, cost and an attribute which indicates whether the resources are renewable or non-renewable.

20. A system for creating maintenance plans for a plurality of equipment comprising:
means for analyzing service requirements of at least two pieces of equipment to standardize the service requirements, at least one of said pieces of equipment having non-standard service requirements;
means for creating standardized service requirements for the at least one piece of equipment having non-standard service requirements; and
means for creating a maintenance plan using the standardized service requirements.

21. The system for claim 20 further comprising means for allocating resources to the maintenance plan.

22. The system for claim 21 further comprising means for determining maintenance schedules from the maintenance plan.

23. The system for claim 20 wherein means for creating standardized service requirements comprises means for resolving semantic heterogeneity between names of activities in the service requirements through the use of ontological domain knowledge.

24. The system for claim 20 wherein the service requirements are determined from equipment state data.

25. The system for claim 20 wherein the service requirements are standardized using data from a maintenance knowledgebase.

26. The system for claim 20 wherein the service requirements are standardized using input from a service schema.

27. The system for claim 20 wherein the service requirements have standardized activity references.

28. The system for claim 20 wherein the service requirements have standardized resource references.

29. A computer readable medium storing computer program instructions for performing a method of creating maintenance plans for a plurality of equipment which, when executed by a processor, perform the steps of:
analyzing service requirements of at least two pieces of equipment to standardize the service requirements, at least one of said pieces of equipment having non-standard service requirements;
creating standardized service requirements for the at least one piece of equipment having non-standard service requirements; and
creating a maintenance plan using the standardized service requirements.

30. The computer readable medium of claim 29 wherein said computer program instructions further perform the step of allocating resources to the maintenance plan.

31. The computer readable medium of claim 29 wherein creating standardized service requirements comprises resolving semantic heterogeneity between names of activities in the service requirements through the use of ontological domain knowledge.

32. The computer readable medium of claim 29 wherein the service requirements are standardized using input from a service schema.
